(19) United States
(12) Patent Application Publication
(10) Pub. No.: US 2017/0090531 A1
(43) Pub. Date: Mar. 30, 2017

(54) A/C ADAPTER DOCK

(71) Applicant: Intel Corporation, Santa Clara, CA (US)

(72) Inventors: Brian S. Forbes, Hillsboro, OR (US); James W. Edwards, Portland, OR (US); Brian R. Peil, Portland, OR (US); Dan H. Gerbus, Aloha, OR (US)

(73) Assignee: INTEL CORPORATION, Santa Clara, CA (US)

(21) Appl. No.: 14/864,922

(22) Filed: Sep. 25, 2015

(51) Int. Cl. G06F 1/20; G06F 1/16

(52) U.S. Cl. CPC G06F 1/203; G06F 1/1632

(57) ABSTRACT

The present techniques are related to an A/C adapter dock. The A/C adapter dock includes an A/C adapter. The A/C adapter includes an air mover and a cradle. The air mover is to create an airflow though the cradle of the A/C adapter. The cradle may include an I/O connector and can receive a computing device for docking at the A/C adapter.

### FIELD

The present techniques generally relate to contextual cooling. More specifically, the present techniques relate to contextual cooling via a power supply.

### BACKGROUND

As computing devices with small form factors continue to become more powerful, their use as replacements for desktop computers has increased. For use as a desktop, computing devices with small form factors may be docked to docking base units for convenient access to additional resources, including a network, a printer, mass storage devices such as hard disk drives, compact disks (CD) or digital video disk (DVD) drives, and other types of peripheral devices. By using a docking unit, such peripheral resources become available once the computing device is docked. Docking a computing device also provides power to the computing device, such that the battery may be recharged and the device would be supplied with power from the mains power supply of a structure, such as a home or office building.

### BRIEF DESCRIPTION OF THE DRAWINGS

FIG. 1A is a block diagram of system including a tablet docked with an A/C adapter;

FIG. 1B is a block diagram of system including a tablet docked with an A/C adapter;

FIG. 2A is an illustration of a system including an A/C adapter dock with a closed tablet cradle;

FIG. 2B is an illustration of a system including an A/C adapter dock with an open tablet cradle;

FIG. 2C is an illustration of a system including an A/C adapter dock with an open tablet cradle and a view of an airflow;

FIG. 2D is an illustration of a system including an A/C adapter dock with an open tablet cradle coupled a computing device;

FIG. 3 is a process flow diagram illustrating a method for contextual cooling; and

FIG. 4 is a block diagram of a system on chip (SoC) on a printed circuit board (PCB).

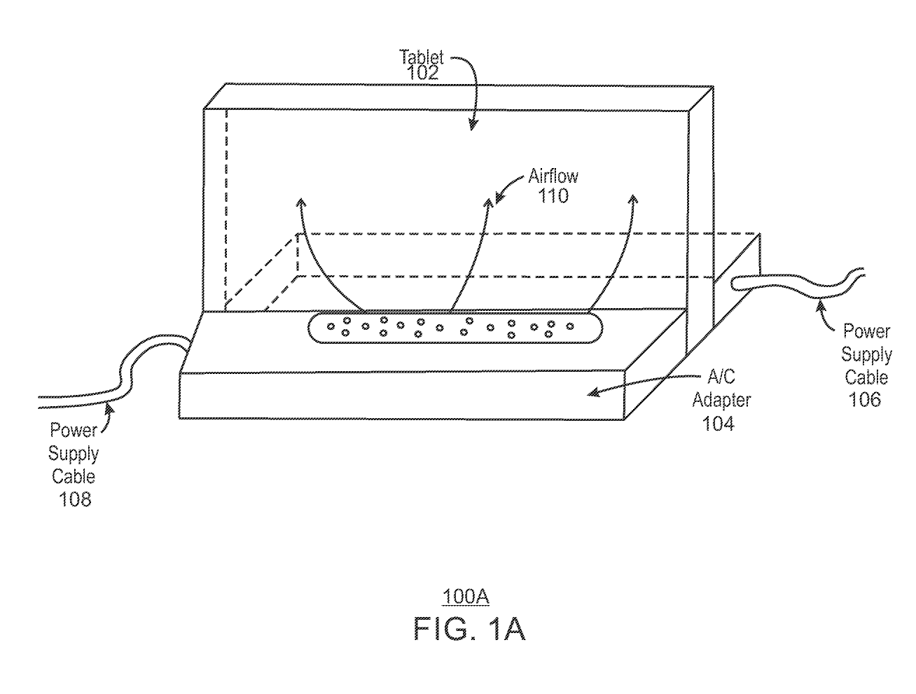

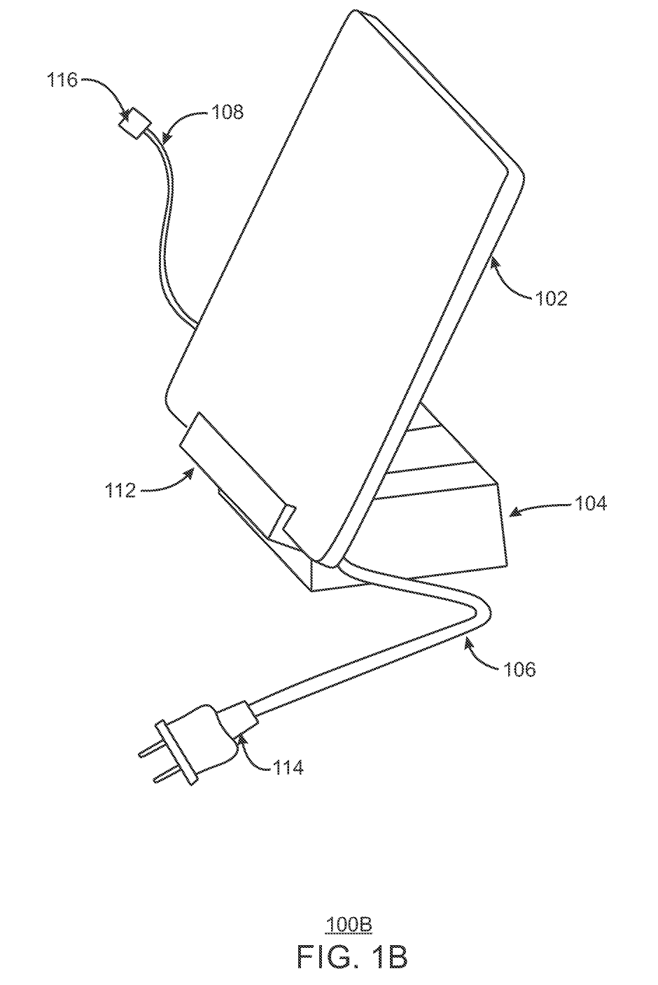

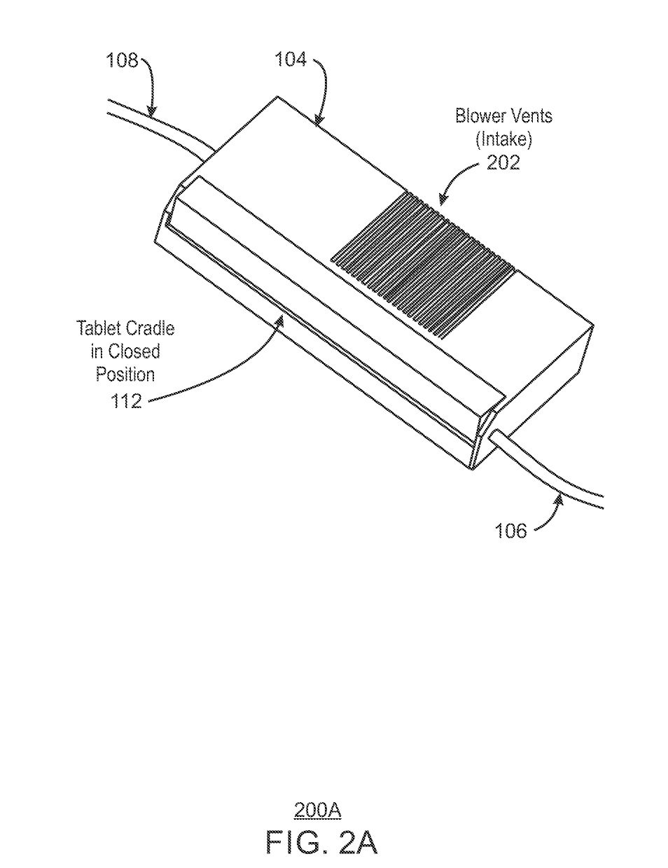

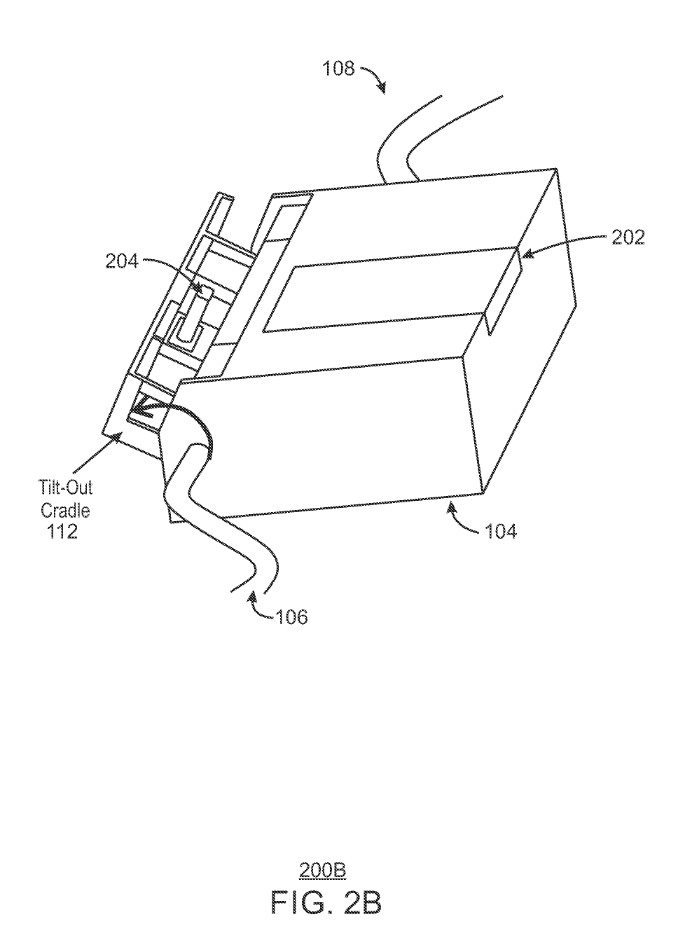

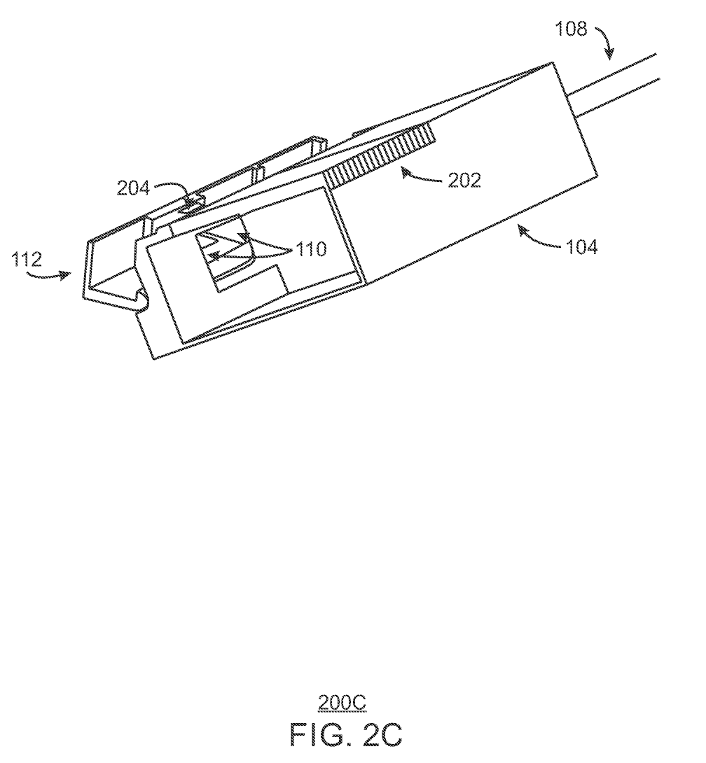

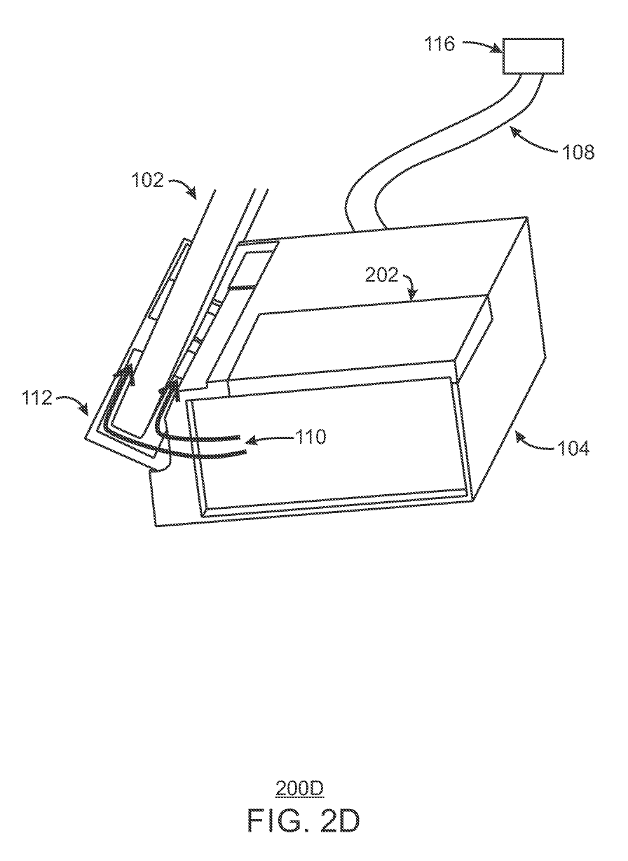

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Docks often enable computing devices to access storage and various peripheral devices in order to provide the functionality of a stationary desktop computing device. As used herein, a computing device generally refers to devices such as tablets, notepads, laptops, mobile phones, smart phones, and the like. Computing devices typically include rechargeable batteries and a corresponding power supply cable to power the computing device and/or recharge the battery of the computing device. Accordingly, the power supply cable can couple with the computing device. The power supply cable may also couple with an electrical outlet in order recharge the batteries of a computing device. The electrical outlet may enable access to the mains power supply of a structure, such as a home or office building. The power supply cable may also provide power directly to the computing device to power the computing device during operation. In embodiments, the power supply cable includes components to convert alternating current (A/C) power from the electrical outlet to direct current (D/C) power. The D/C power is then routed to the computing device.

Power supply cables are typically provided when the computing device is purchased by a consumer. However, docking stations are not typically provided as a part of a consumer's initial purchase, and represent an additional cost to the consumer. Embodiments described herein provide an A/C adapter dock for contextual cooling. In embodiments, the A/C adapter functions as a dock. The A/C adapter may include an in line configuration with the power supply cable of the computing device. In embodiments, the A/C adapter includes a cradle and an air mover.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

FIG. 1A is a block diagram of system 100A including a tablet docked with an A/C adapter. Although the present techniques are described using a tablet, any computing device may be used. Additionally, the A/C adapter, as used herein, can refer to any device that is to rectify electricity for use by a computing device. The term A/C adapter is used for ease of description, however, the present techniques also apply to an AC/DC adapter, AC/DC converter, plug pack, plug-in adapter, adapter block, domestic mains adapter, line power adapter, wall wart, power adapter, power brick, and the like.

The tablet 102 is docked with an A/C adapter dock 104. The A/C adapter dock 104 includes a power supply cable with two ends: end 106 and end 108. In embodiments, the A/C adapter, end 106 and end 108 are configured as an A/C adapter or power brick in-line type of AC adapter. Electricity is obtained from an electrical outlet via power supply cable end 106. The electricity enters the A/C adapter dock 104 from the power supply cable end 106, and includes components to convert the A/C power to D/C power for use by the computing device. For example, the A/C adapter dock 104 can include a transformer to convert the voltage from the A/C power supply of a building to a lower voltage, a rectifier to convert it to pulsating waveform, and a filter to smooth the pulsating waveform to D/C. D/C power can be delivered from the A/C adapter dock 104 to the tablet 102 or other device via the power supply cable end 108.

In embodiments, the A/C adapter dock 104 may include a one or more air movers to create a flow of air to cool to the tablet 102. In embodiments, the air mover is a fan or blower. Additionally, in embodiments, the air mover is an electrokinetic system. The air mover may cause an airflow from the exterior of the A/C adapter dock 104, through the A/C adapter dock 104, and across the tablet 102. In embodiments, the airflows over both sides of the tablet 102 and around the tablet 102. As use of the tablet 102 becomes computationally complex and requires use of several processing components of the tablet, heating of the tablet may also increase as a direct result of additional processing. For example, when the tablet is used in high performance applications, the processing done by the tablet may cause additional heat to be generated. Through the present techniques, cooling of the tablet is enhanced, thereby enabling high performance of the tablet since additional heat is removed by the airflow from the A/C adapter. Another air mover may also be configured to cool the A/C adapter components as necessary. In some embodiments, the A/C adapter dock 104 and the tablet 102 are cooled by an airflow produced by the same air mover. An airflow 110 is directed from the A/C adapter dock 104 to the tablet 102. In this manner, the tablet 102 can be cooled by the airflow 110 from the A/C adapter dock 104. In embodiments, the tablet is cooled in a contextual fashion, such that the airflow is a function of the context of use for the tablet 102. In embodiments, the airflow may be a multi-speed airflow.

FIG. 1B is a block diagram of system 100B including a tablet docked with an A/C adapter. As illustrated, the tablet 102 is docked with the A/C adapter dock 104. The system 100B illustrates a cradle 112. The cradle 112 is open, and holds the tablet 102. Similar to FIG. 1 B, the A/C adapter dock 104 includes a power supply cable with two ends: end 106 and end 108. The power supply cable end 106 terminates in an electrical plug 114. In embodiments, the electrical plug 114 is an A/C power plug that enables a connection with the A/C power supply of a building. The mains supply provides electricity to a building, and various devices can access power via an electrical outlet. FIG. 100B illustrates a Type A electrical plug, however, any electrical plug, socket, or voltage can be used according to the present techniques.

The power supply cable end 108 includes a connector 116. In embodiments, the connector 116 is a Universal Serial Bus (USB) Type-C connector. The USB Type-C connector is defined according to the USB Type-C Specification 1.0, released Aug. 11, 2014. The USB Type-C connector is a USB connector that is smaller than previous USB connectors and that enables a connection with a USB receptacle at any orientation. In some cases, the USB Type-C connector is a primary charging connector of a USB device. In embodiments, the A/C adapter enables support of the USB Power Delivery Specification, Revision 2.0, released Aug. 11, 2014. Additionally, the A/C adapter may enable support of charging according to the USB Battery Charging Specification 1.2, released Dec. 7, 2010. Although a USB Type-C connector is described herein, any type of I/O connector can be used.

In embodiments, when a computing device is not docked with the A/C adapter dock, the connector 116 may be used to deliver power to a computing device. In embodiments, the A/C adapter dock may be a “smart” A/C adapter dock and can transmit additional power information to the computing device via the connector 116. In embodiments, a connector similar to the connector 116 is contained within the cradle 112 such that power and communication between the tablet 102 and the adapter dock 104 is transferred while the tablet 102 is docked. Alternatively, the AC adapter dock 104 may provide power wirelessly to the tablet 102 via inductive charging or similar technology while docked, and communication via Bluetooth or similar wireless communication technologies. In such a wireless charging embodiment, the need another connector within the cradle 112 may be eliminated. Bluetooth communication may refer to communication according to any Bluetooth specification, such as Bluetooth version 4.2, released Dec. 2, 2014.

FIG. 2A is an illustration of a system 200A including an A/C adapter dock with a closed tablet cradle. The system 200A includes the A/C adapter dock 104, a power cable supply end 106, and a power supply cable end 108. Intake air vents 202 are illustrated on the A/C adapter dock 104. In embodiments, the intake air vents 202 are used to draw air from the surrounding environment and force the air across a computing device docked with the A/C adapter dock. FIG. 2A illustrates the A/C adapter dock in a closed position. In the closed position, an air mover would not blow air, as a computing device is not docked with the A/C adapter dock.

FIG. 2B is an illustration of a system 200B including an A/C adapter dock with an open tablet cradle. The system 200 includes an A/C adapter dock 104, a power cable supply end 106, and a power supply cable end 108. In FIG. 2B, the cradle has been tilted outwards to prepare for docking with a tablet. Although a tilt-out cradle is illustrated, the cradle may slide out, be recessed, raised, or integrated into the surface of the A/C adapter 104. Moreover, cradle components may be initially concealed, and “pop-up” to receive a computing device for docking at the A/C adapter dock. Additionally, in embodiments, the A/C adapter dock includes a plurality of ports that are to couple a plurality of peripheral devices with a computing device docket with the A/C adapter dock via the cradle.

The cradle 112 also includes an I/O connector 204. In embodiments, the I/O connector enables several connection types. In embodiments, the I/O connector 204 may be a connector according to various standards, such as USB Type-C, USB2, USB3, PCIe, HDMI, DisplayPort, and so on. The USB Type-C standard can be used to enable connection types such as the USB2, USB3, PCIe, HDMI, DisplayPort, and the like. In embodiments, the I/O connector 204 is a USB Type-C connector. Moreover, in embodiments, data transfer across the USB Type-C connector is according to any standard supported by the USB Type-C Specification. The USB2 is according to the Universal Serial Bus 2.0 Specification released April 2000. The USB3 is according to the Universal Serial Bus 3.1 Specification released on July, 2013. A High-Definition Multimedia Interface (HDMI) connection may be according to the HDMI Specification Ver. 2.0 released September 2013. DisplayPort (DP) may be according to the DisplayPort 1.3 released September 2014.

FIG. 2C is an illustration of a system 200C including an A/C adapter dock with an open tablet cradle and a view of an airflow. In FIG. 2C, an exemplary airflow 110 through the A/C adapter dock 104 is illustrated. Although a particular airflow is illustrated, the airflow through the adapter can be arranged in a number of configurations. In embodiments, channels through the A/C adapter dock guide the airflow through the A/C adapter dock. Additionally, channels located on the cradle 112 can guide air from the airflow 110 around the front side and back side of the computing device when docked with the A/C adapter dock. While the airflow is described as flowing across the front/back surfaces of the tablet, in embodiments a vent or opening on the tablet enables an airflow through the tablet.

FIG. 2D is an illustration of a system 200D including an A/C adapter dock with an open tablet cradle coupled a computing device. As illustrated, a tablet 102 is docked with the A/C adapter dock via the cradle 112. A cooling airflow 110 is directed across the tablet 102 through the cradle 112. In embodiments, airflow would be tuned between front and rear of the computing device via channels, baffles, and other appropriate air restrictors within the A/C adapter dock and on the cradle 112.

In embodiments, when a computing device is docked at the A/C adaptor dock via the cradle, additional cooling is available from the A/C adapter dock. The additional cooling enables processing units of the computing device to increase performance, including but not limited to an increase in a processing core's clock upper speeds. This enables the computing device to be more adept when processing heavy workloads, such as gaming, streaming videos, or any other workload that causes a high amount of processing activity. Such a cooling scheme may be referred to as Adaptive Performance. Moreover, docking the enables an unlimited supply of power rather than the device running off of a finite supply of battery power. The access to unlimited power enables higher power modes that might not be available while running solely off of power from a battery.

Additionally, in embodiments, the I/O connector (204, FIG. 2B) enables the computing device to be communicatively coupled with another device via the connector 116. The tablet 102 includes a female port configured to be coupled with the I/O connector (204, FIG. 2B) in order to dock the tablet 102 with the A/C adapter dock 104. The A/C adapter dock 104 may include a microcontroller that is to implement cooling according to an Adaptive Performance scheme. Via the connector 116, a user can further connect the tablet 102 or the dock 104 to specific endpoints like USB devices, audio headsets, or DisplayPort displays. In embodiments, the tablet 102 may control the air mover via the connector 204. The tablet can control the volume of air and the speed of air output by the air mover. The air mover may be enumerated by the tablet as a USB device that is discovered after docking. In this manner, the tablet can monitor the state of power management of its system elements with the additional cooling functionality from the A/C adapter dock.

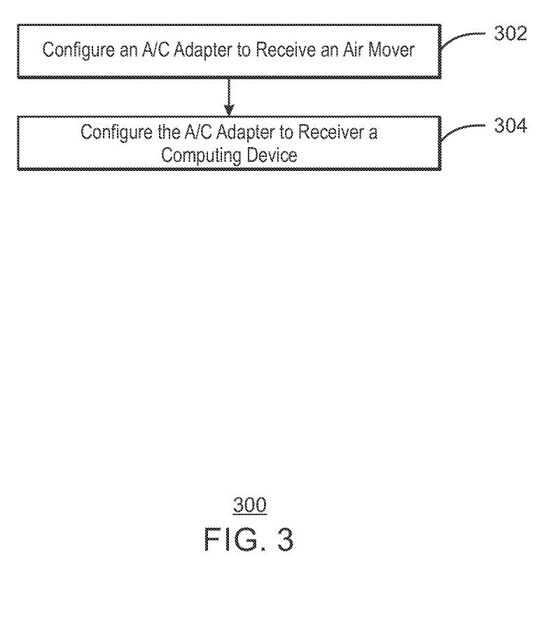

FIG. 3 is a process flow diagram illustrating a method 300 for contextual cooling. At block 302, an A/C adapter is configured to receive an air mover. In embodiments, the air mover is configured to move air surrounding the A/C adapter through the A/C adapter and across a computing device docked with the A/C adapter. At block 304, the A/C adapter is configured to receive a computing device. In embodiments, a cradle is formed along a portion of the A/C adapter. The cradle may include an I/O connector and can receive a computing device for docking at the A/C adapter. In response to the computing device docking with the AC adapter, the A/C adapter can direct air from the air mover across the tablet.

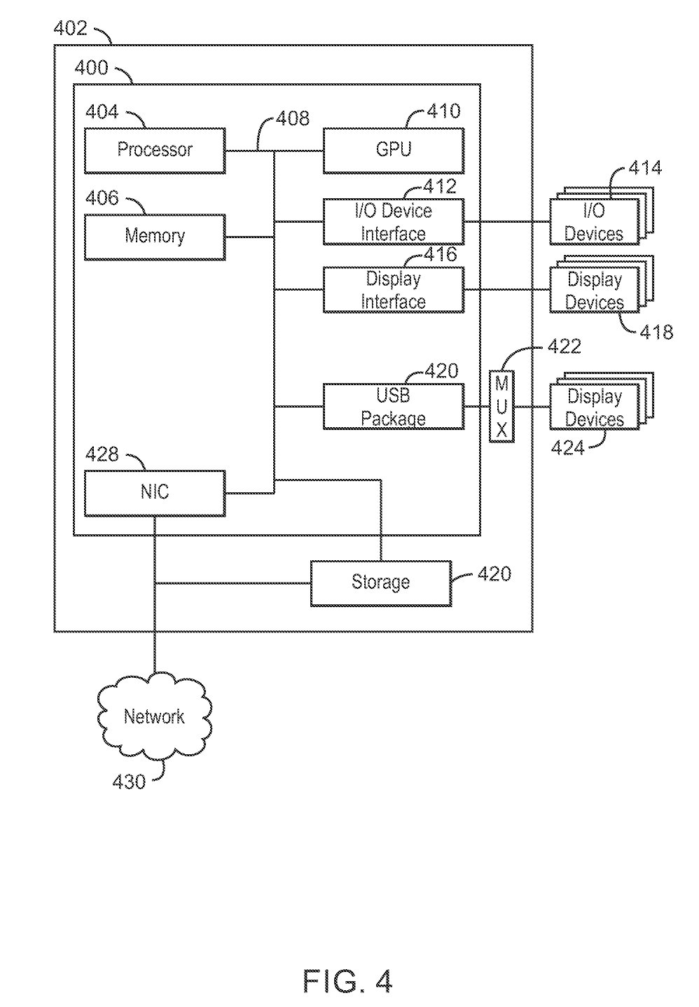

FIG. 4 is a block diagram of a system on chip (SoC) 400 on a printed circuit board (PCB) 402. The SoC 400 and PCB 402 may be components of, for example, a computing device such as a laptop computer, desktop computer, Ultrabook, tablet computer, mobile device, or server, among others. The computing device may be coupled with an A/C adapter dock as described herein. The SoC 400 may include a central processing unit (CPU) 404 that is configured to execute stored instructions, as well as a memory device 406 that stores instructions that are executable by the CPU 404. The CPU may be coupled to the memory device 406 by a bus 408. Additionally, the CPU 404 can be a single core processor, a multi-core processor, a computing cluster, or any number of other configurations. Furthermore, the SoC 400 may include more than one CPU 404.

The SoC 400 may also include a graphics processing unit (GPU) 410. As shown, the CPU 404 may be coupled through the bus 408 to the GPU 410. The GPU 410 may be configured to perform any number of graphics functions and actions. For example, the GPU 410 may be configured to render or manipulate graphics images, graphics frames, videos, or the like, to be displayed to a user of the SoC 400. The memory device 406 can include random access memory (RAM), read only memory (ROM), flash memory, or any other suitable memory systems. For example, the memory device 406 may include dynamic random access memory (DRAM).

The CPU 404 may be connected through the bus 408 to an input/output (I/O) device interface 412 configured to connect the SoC 400 through various layers of the PCB 402, and components of the PCB 402 to one or more I/O devices 414. The I/O devices 414 may include, for example, a keyboard and a pointing device, wherein the pointing device may include a touchpad or a touchscreen, among others. The I/O devices 414 may be built-in components of a platform including the SoC 400, or may be devices that are externally connected to a platform including the SoC 400. In embodiments, the I/O devices 414 are coupled with a computing device including the SOC 400 via an A/C adapter dock.

The CPU 404 may also be linked through the bus 408 to a display interface 416 configured to connect the SoC 400 through various layers of the PCB 402, and components of the PCB 402 to one or more display devices 418. The display device(s) 418 may include a display screen that is a built-in component of a platform including the SoC 400. Examples of such a computing device include mobile computing devices, such as cell phones, tablets, 2-in-1 computers, notebook computers or the like. The display device 418 may also include a computer monitor, television, or projector, among others, that is externally connected to the SoC 400. In embodiments, the display devices 418 is coupled with a computing device including the SOC 400 via an A/C adapter dock.

The USB package 420 may include a transmitter and a receiver in order to transmit and receive USB data. The USB package 420 may also include components necessary to implement the USB Battery Charging Specification, USB On-the-Go Specification, and the USB Power Delivery Specification, and the USB Type-C Specification. The PCB 402 may also include components to implement the various USB Specifications. Data from the USB package 420 may be sent to a multiplexer (MUX) 422 and on to a plurality of USB devices 424. The MUX 422 may be used to select between various USB features enabled by the USB package 420. For example, the MUX 422 may be used to implement USB 2.0, USB 3.0, USB Battery Charging, USB Power Delivery, HDMI, DisplayPort, or PCIe, among others. In embodiments, the USB devices 414 are coupled with a computing device including the SOC 400 via an A/C adapter dock.

The SoC 400 may also be coupled with a storage device 426. The storage device may be a component located on the PCB 402. Additionally, the storage device 426 can be a physical memory such as a hard drive, an optical drive, a thumb drive, an array of drives, or any combinations thereof. The storage device 426 may also include remote storage drives. The SoC 400 may also include a network interface controller (NIC) 428 may be configured to connect the SoC 400 through the bus 408, various layers of the PCB 402, and components of the PCB 402 to a network 430. The network 430 may be a wide area network (WAN), local area network (LAN), or the Internet, among others.

It is to be understood that the block diagram of FIG. 4 is not intended to indicate that the SoC 400 is to include all of the components shown in FIG. 4. Rather, the SoC 400 can include fewer or additional components not illustrated in FIG. 4. Furthermore, the components may be coupled to one another according to any suitable system architecture, including the system architecture shown in FIG. 4 or any other suitable system architecture that uses a data bus to facilitate communications between components. For example, embodiments of the present techniques can also be implemented any suitable electronic device, including ultra-compact form factor devices, such as SoC and multi-chip modules.

Example 1 is an A/C adapter dock. The A/C adapter dock includes an A/C adapter, wherein the A/C adapter comprises: an air mover; and a cradle, wherein the air mover is to create an airflow though the cradle of the A/C adapter.

Example 2 includes the A/C adapter dock of example 1, including or excluding optional features. In this example, the cradle is to receive a computing device.

Example 3 includes the A/C adapter dock of any one of examples 1 to 2, including or excluding optional features. In this example, the cradle is a tilt-out cradle.

Example 4 includes the A/C adapter dock of any one of examples 1 to 3, including or excluding optional features. In this example, the cradle comprises an I/O connector.

Example 5 includes the A/C adapter dock of any one of examples 1 to 4, including or excluding optional features. In this example, the A/C adapter dock includes a plurality of ports, wherein the plurality of ports are to couple a plurality of peripheral devices with a computing device docket with the A/C adapter dock via the cradle.

Example 6 includes the A/C adapter dock of any one of examples 1 to 5, including or excluding optional features. In this example, the airflow is a multi-speed airflow.

Example 7 includes the A/C adapter dock of any one of examples 1 to 6, including or excluding optional features. In this example, the cradle is a slide out cradle.

Example 8 includes the A/C adapter dock of any one of examples 1 to 7, including or excluding optional features. In this example, the cradle is a recessed cradle.

Example 9 includes the A/C adapter dock of any one of examples 1 to 8, including or excluding optional features. In this example, the air mover is a fan.

Example 10 includes the A/C adapter dock of any one of examples 1 to 9, including or excluding optional features. In this example, the air mover is a blower.

Example 11 includes the A/C adapter dock of any one of examples 1 to 10, including or excluding optional features. In this example, the air mover is an electrokinetic system.

Example 12 is a system that provides an A/C adapter dock. The system includes an A/C adapter, wherein the A/C adapter comprises: an air mover; and a cradle, wherein the cradle is configured to dock with a computing device, and wherein the air mover is to create an airflow though the cradle of the A/C adapter and across the computing device.

Example 13 includes the system of example 12, including or excluding optional features. In this example, the cradle includes air restrictors to guide the airflow across the computing device.

Example 14 includes the system of any one of examples 12 to 13, including or excluding optional features. In this example, the computing device includes vents and air restrictors of the cradle are to guide the airflow through vents of the computing device.

Example 15 includes the system of any one of examples 12 to 14, including or excluding optional features. In this example, the cradle is a tilt-out cradle.

Example 16 includes the system of any one of examples 12 to 15, including or excluding optional features. In this example, the cradle comprises an I/O connector.

Example 17 includes the system of any one of examples 12 to 16, including or excluding optional features. In this example, the system includes a plurality of ports, wherein the plurality of ports are to couple a plurality of peripheral devices with a computing device docket with the system via the cradle.

Example 18 includes the system of any one of examples 12 to 17, including or excluding optional features. In this example, the airflow is a multi-speed airflow.

Example 19 includes the system of any one of examples 12 to 18, including or excluding optional features. In this example, the cradle is a slide out cradle.

Example 20 includes the system of any one of examples 12 to 19, including or excluding optional features. In this example, the cradle is a recessed cradle.

Example 21 includes the system of any one of examples 12 to 20, including or excluding optional features. In this example, the air mover is a fan.

Example 22 includes the system of any one of examples 12 to 21, including or excluding optional features. In this example, the air mover is a blower.

Example 23 includes the system of any one of examples 12 to 22, including or excluding optional features. In this example, the air mover is an electrokinetic system.

Example 24 is a method for configuring an A/C adapter dock. The method includes configuring an A/C adapter to receive an air mover that is to generate an airflow and configuring the A/C adapter to receive a computing device.

Example 25 includes the method of example 24, including or excluding optional features. In this example, the A/C adapter comprises a tilt-out cradle to receive the computing device. Optionally, the cradle comprises an I/O connector.

Example 26 includes the method of any one of examples 24 to 25, including or excluding optional features. In this example, the method includes a plurality of ports, wherein the plurality of ports are to couple a plurality of peripheral devices with a computing device docket with the method via the cradle.

Example 27 includes the method of any one of examples 24 to 26, including or excluding optional features. In this example, the airflow is a multi-speed airflow.

Example 28 includes the method of any one of examples 24 to 27, including or excluding optional features. In this example, the A/C adapter comprises a slide-out cradle to receive the computing device.

Example 29 includes the method of any one of examples 24 to 28, including or excluding optional features. In this example, the A/C adapter comprises a recessed cradle to receive the computing device.

Example 30 includes the method of any one of examples 24 to 29, including or excluding optional features. In this example, the air mover is a fan.

Example 31 includes the method of any one of examples 24 to 29, including or excluding optional features. In this example, the air mover is a blower.

Example 32 includes the method of any one of examples 24 to 29, including or excluding optional features. In this example, the air mover is an electrokinetic system.

Example 33 is a tangible, non-transitory, computer-readable medium. The computer-readable medium includes instructions that direct the processor to configure an A/C adapter to receive an air mover, and in response to docking with a computing device, configure the A/C adapter to cool the computing device via an airflow.

Example 34 includes the computer-readable medium of example 33, including or excluding optional features. In this example, the A/C adapter comprises a tilt-out cradle to receive the computing device. Optionally, the cradle comprises an I/O connector.

Example 35 includes the computer-readable medium of any one of examples 33 to 34, including or excluding optional features. In this example, the computer-readable medium includes a plurality of ports, wherein the plurality of ports are to couple a plurality of peripheral devices with a computing device docket with the computer-readable medium via the cradle.

Example 36 includes the computer-readable medium of any one of examples 33 to 35, including or excluding optional features. In this example, the airflow is a multi-speed airflow.

Example 37 includes the computer-readable medium of any one of examples 33 to 36, including or excluding optional features. In this example, the A/C adapter comprises a slide-out cradle to receive the computing device.

Example 38 includes the computer-readable medium of any one of examples 33 to 37, including or excluding optional features. In this example, the A/C adapter comprises a recessed cradle to receive the computing device.

Example 39 includes the computer-readable medium of any one of examples 33 to 38, including or excluding optional features. In this example, the air mover is a fan.

Example 40 includes the computer-readable medium of any one of examples 33 to 38, including or excluding optional features. In this example, the air mover is a blower.

Example 41 includes the computer-readable medium of any one of examples 33 to 38, including or excluding optional features. In this example, the air mover is an electrokinetic system.

Example 42 is an apparatus. The apparatus includes instructions that direct the processor to an means to convert A/C power to D/C power, wherein the means to convert A/C power to D/C power comprises: an air mover; and a cradle, wherein the air mover is to create an airflow though the cradle of the means to convert A/C power to D/C power.

Example 43 includes the apparatus of example 42, including or excluding optional features. In this example, the cradle is to receive a computing device.

Example 44 includes the apparatus of any one of examples 42 to 43, including or excluding optional features. In this example, the cradle is a tilt-out cradle.

Example 45 includes the apparatus of any one of examples 42 to 44, including or excluding optional features. In this example, the cradle comprises an I/O connector.

Example 46 includes the apparatus of any one of examples 42 to 45, including or excluding optional features. In this example, the apparatus includes a plurality of ports, wherein the plurality of ports are to couple a plurality of peripheral devices with a computing device docket with the means to convert A/C power to D/C power dock via the cradle.

Example 47 includes the apparatus of any one of examples 42 to 46, including or excluding optional features. In this example, the airflow is a multi-speed airflow.

Example 48 includes the apparatus of any one of examples 42 to 47, including or excluding optional features. In this example, the cradle is a slide out cradle.

Example 49 includes the apparatus of any one of examples 42 to 48, including or excluding optional features. In this example, the cradle is a recessed cradle.

Example 50 includes the apparatus of any one of examples 42 to 49, including or excluding optional features. In this example, the air mover is a fan.

Example 51 includes the apparatus of any one of examples 42 to 49, including or excluding optional features. In this example, the air mover is a blower.

Example 52 includes the apparatus of any one of examples 42 to 49, including or excluding optional features. In this example, the air mover is an electrokinetic system.

In the foregoing description, numerous specific details have been set forth, such as examples of specific types of system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

In the above description and the following claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices.

An embodiment is an implementation or example. Reference in the present specification to “an embodiment”, “one embodiment”, “some embodiments”, “various embodiments”, or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An A/C adapter dock, comprising:
an A/C adapter, wherein the A/C adapter comprises:
an air mover; and
a cradle, wherein the air mover is to create an airflow though the cradle of the A/C adapter.

2. The A/C adapter dock of claim 1, wherein the cradle is to receive a computing device.

3. The A/C adapter dock of claim 1, wherein the cradle is a tilt-out cradle.

4. The A/C adapter dock of claim 1, wherein the cradle comprises an I/O connector.

5. The A/C adapter dock of claim 1, further comprising a plurality of ports, wherein the plurality of ports are to couple a plurality of peripheral devices with a computing device docket with the A/C adapter dock via the cradle.

6. The A/C adapter dock of claim 1, wherein the airflow is a multi-speed airflow.

7. The A/C adapter dock of claim 1, wherein the cradle is a slide out cradle.

8. The A/C adapter dock of claim 1, wherein the cradle is a recessed cradle.

9. The A/C adapter dock of claim 1, wherein the air mover is a fan.

10. The A/C adapter dock of claim 1, wherein the air mover is a blower.

11. The A/C adapter dock of claim 1, wherein the air mover is an electrokinetic system.

12. A system that provides an A/C adapter dock, comprising:
an A/C adapter, wherein the A/C adapter comprises:
an air mover; and
a cradle, wherein the cradle is configured to dock with a computing device, and wherein the air mover is to create an airflow though the cradle of the A/C adapter and across the computing device.

13. The system of claim 12, wherein the cradle includes air restrictors to guide the airflow across the computing device.

14. The system of claim 12, wherein the computing device includes vents and air restrictors of the cradle are to guide the airflow through vents of the computing device.

15. The system of claim 12, further comprising a plurality of ports, wherein the plurality of ports are to couple a plurality of peripheral devices with a computing device docket with the system via the cradle.

16. A method for configuring an A/C adapter dock, comprising:
configuring an A/C adapter to receive an air mover; and
configuring the A/C adapter to receive a computing device.

17. The method of claim 16, wherein the A/C adapter comprises a tilt-out cradle to receive the computing device.

18. The method of claim 16, wherein the A/C adapter comprises a cradle to receive the computing device, and the cradle comprises an I/O connector.

19. The method of claim 16, further comprising a plurality of ports, wherein the plurality of ports are to couple a plurality of peripheral devices with a computing device docket with the method via the cradle.

20. The method of claim 16, wherein the airflow is a multi-speed airflow.

21. The method of claim 16, wherein the A/C adapter comprises a slide-out cradle to receive the computing device.

22. The method of claim 16, wherein the A/C adapter comprises a recessed cradle to receive the computing device.

23. A tangible, non-transitory, computer-readable medium comprising instructions that, when executed by a processor, direct the processor to:
configure an A/C adapter to receive an air mover; and
in response to docking with a computing device, configure the A/C adapter to cool the computing device via an airflow.

24. The computer-readable medium of claim 23, wherein the A/C adapter comprises a tilt-out cradle to receive the computing device.

25. The computer-readable medium of claim 23, wherein a cradle of the A/C adapter comprises an I/O connector.
